(19) United States
(12) Patent Application Publication
(10) Pub. No.: US 2017/0039574 A1
(43) Pub. Date: Feb. 9, 2017

(54) RESIDENTIAL FUEL TANK ANALYSIS AND MANAGEMENT SYSTEM

(71) Applicant: BOSTON ENVIRONMENTAL, LLC, Portsmouth, NH (US)

(72) Inventor: Kyle Koerber, Chebeague Island, ME (US)

(21) Appl. No.: 14/819,837

(22) Filed: Aug. 6, 2015

(51) Int. Cl. G06Q 30/00; G06Q 50/06

(52) U.S. Cl. CPC G06Q 30/018; G06Q 50/06

(57) ABSTRACT

A data collection system for the management of a variety of safety related inspections and documentation related to requirements, regulations and best practice within the retail-supply side of the propane industry is described. The system is especially useful for identifying and cataloguing corrective action maintenance requirements such as tank inspections, regulator replacements and recalls. Another benefit of the system is to identify inspections that are incomplete or incorrect and thus facilitating targeted retraining of technicians that focusses safety related issues. The system provides the propane dealer with information from an entire portfolio of inspection data in order to implement a process of compliance with existing regulation.

### STATEMENT REGARDING FEDERALLY SPONSORED RESEARCH OR DEVELOPMENT

Not Applicable

### INTRODUCTION

Various embodiments relate generally to fuel tank monitoring systems, methods, devices and computer programs and, more specifically, relate to data analysis and management for analyzing the condition of fuel tank systems and determining inspection requirements.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Propane gas for residential and business heating systems is usually stored in a tank at the premises where the heating system is located. For residential installations the propane fuel tank is located outside the home, either in an above ground or underground steel storage tank. Deterioration of the propane fuel tank and other components (such as regulators, valves, couplings and lines, for example) over time can result in leakage with consequent damage from fire, explosion, or in the case of underground tanks environmental contamination. Above ground propane fuel tanks and components are usually visually inspected by propane dealers at the time a new customer is added to the delivery service, at the time a new propane appliance is installed, or when the integrity of the system at large is in question. For example, the integrity of the system can be called into question when a service person or home owner smells a propane gas odor. Underground storage tanks are inspected via a cathodic protection test on timetables specified by the NFPA and or state regulation, which is every three years unless state regulations are stricter than NFPA. A cathodic protection test determines if the underground tank's sacrificial anode, which prevents corrosion, has deteriorated to the point of needing replacement. If a periodic test requires that the anode be replaced, then some level of excavation is required to replace the device.

Currently, many in the industry utilize paper inspection forms for the numerous inspections required that have been designed in collaboration between the insurance industry, NFPA and the key national trade associations representing propane suppliers.

As a result, there is no IT system available that can analyze data compiled on a paper-driven and filing platform and produce important indices that drive safety compliance.

Customer portfolios of propane suppliers can range from several hundred to tens of thousands. Propane dealers typically cannot utilize the information currently garnered through the industry-wide inspection process to do more than assess an individual system based on the inspection on the day of that inspection. It would be beneficial to have an electronic system for predicting the required tests and inspections, by individual customer the entire portfolio of customers of any given propane dealer.

### SUMMARY

The below summary is merely representative and non-limiting.

The above problems are overcome, and other advantages may be realized, by the use of the embodiments.

In a first aspect, an embodiment provides a data analysis and management system for analyzing the condition of propane systems (tanks, regulators, lines, cathodic protection timetables, etc.) and projecting needed and future inspection requirements, by individual customer account. The system is especially useful for monitoring residential delivery portfolios of thousands of customers and directing the inspections process and resources based upon individual risk profiles within the broader portfolio.

A primary benefit of the system is to electronically catalogue the paper-driven information and filing system into an e-driven database which facilitates exacting inspection and maintenance action steps across a dealer's entire customer portfolio.

The system comprises a computer database management system located at a central computer, and one or more remotely located data entry terminals for entry into the database of applicable data, preferably via an internet or web browser. Typically the data entry terminals, which are usually personal computers, are located at the facilities of propane dealers who are using the system. The database is maintained on a server computer disposed at the facility of the provider of the system.

In operation, each dealer having access to the system logs on to the provider's web site to gain access to the system for entry of data for the dealer's customers' inspections which can include leak checks, pressure tests, safety inspections, cathodic protection inspections, DOT tank replacement and refurbishment requirements, compliance with CSST (Corrugated Stainless Steel Tubing) installation requirements and other related system inspections.

Various inspection data is entered into the system via paper-driven data entry or wireless e-tablets or similar devices depending on the dealer's preference. The system then catalogues the information and analyzes each inspection for completeness and technical accuracy. Algorithms determine certain technical accuracy for pressure tests and related hold-time requirements and for leak check inspections. Inspections that fall out of the accepted norms are flagged for retesting or management review.

The system analyzes, for each inspection in the system, data on technical accuracy and garners inspections details to alert management to timetables for all inspection types required by NFPA, insurance underwriters, unique state requirements, and other universally accepted best practices. Individual customer accounts can also be populated with pictures of tanks or equipment and a pdf of the original inspection document.

Safety related liability for both propane dealers and homeowners is largely allied to the quality of and accuracy of inspection data. Because the system can analyze data on a per inspection basis and identify when a technical inspection process was done incorrectly or incompletely potentially dangerous circumstances can be averted or identified for reevaluation.

### BRIEF DESCRIPTION OF THE DRAWINGS

Aspects of the described embodiments are more evident in the following description, when read in conjunction with the attached Figures.

FIG. 1 is a diagrammatic illustration of a user's process flow using a data communications system in accordance with an embodiment.

FIG. 2 is an illustration of an example Propane Safety Inspection and/or New Equipment Installation form.

FIG. 3 is an illustration of an example Cathodic Protection Inspection form.

FIG. 4 is an illustration of an example Interruption of Service Inspection form.

FIG. 5 is an illustration of an example Odor Complaint/Gas Leak inspection form.

FIG. 6 is an illustration of an example 5 Year Visual Inspection for DOT tanks.

FIG. 7 is an illustration of an example Propane Tune Up Inspection form.

FIG. 8 is an illustration of an example Propane Customer Service and Gas System Agreement form.

FIG. 9 is an illustration of an example Property Owner or Tenant Duty to Warn Agreement form.

FIG. 10 shows a home web page for use in an embodiment.

FIG. 11 shows a home web page for choosing Administrative options of an embodiment.

FIG. 12 shows a web page for entering various form data.

FIG. 13 shows a web page for entry of Safety Inspection data.

FIG. 14 shows a web page for entry of Cathodic Protection data.

FIG. 15 shows a web page for choosing various reports available in the system and a user dashboard summary of actionable corrective actions.

FIG. 16 shows a list of Safety Inspections by homeowner with a drill-down to a specific actionable issue.

FIG. 17 shows a Cathodic Protection report and a drill-down to an image of the original inspection/inspection date which triggers a new inspection based on required timetables.

FIG. 18 shows a Photo Documentation feature.

FIG. 19 shows a Photo Documentation Flash Report indicating deficiencies in completeness.

FIG. 20 shows the Photo Documentation Flash Report indicating a specific customer account.

FIG. 21 shows a dash board/flash report of all documentations that are in need of some sort of corrective action.

FIG. 22 shows a simplified block diagram of a device that is suitable for practicing various embodiments.

FIG. 23 is a logic flow diagram that illustrates the operation of a method, and a result of execution of computer program instructions embodied on a computer readable memory, in accordance with various embodiments.

### DETAILED DESCRIPTION

In one, non-limiting embodiment, the system is operated by a service provider which maintains a server computer containing database management software at its facility. Customers of the service provider are usually propane dealers who are provided access to the system via the dealer's own computer which communicates with the service provider's central computer via the Internet. The system may accommodate a multitude of users via independent computers based at the dealer's location(s). The central computer is a cloud based application accessible anywhere the Internet is available.

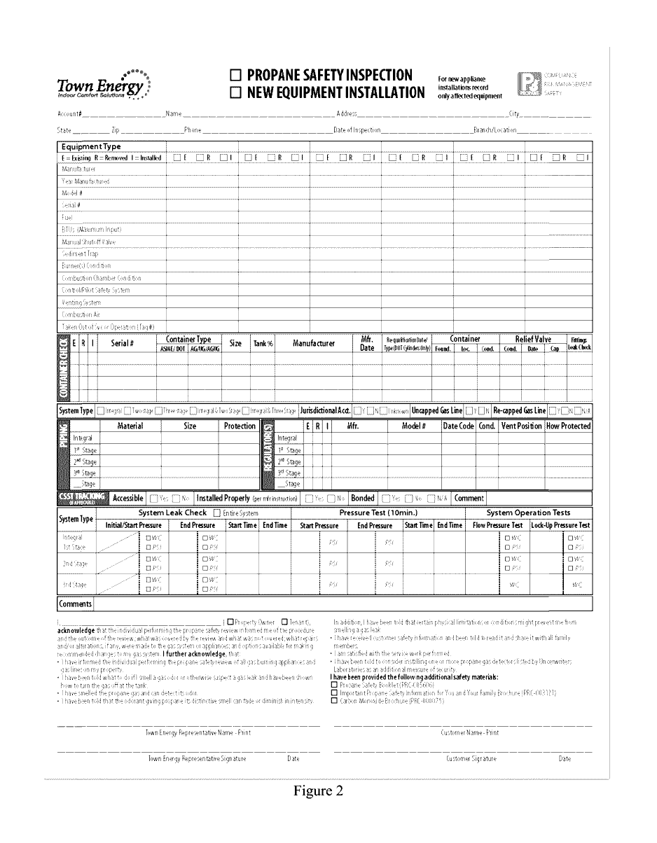

Data on the propane tank systems of the propane dealer's customers is obtained by the dealer's service technicians. During a visit to the customer's premises, at which a tank is located, the technician obtains data on the particular tank system. The data obtained can be specific to the inspection being conducted and the reason for that inspection. This information may also include: the condition of the tank, manufacturers data on the regulator, propane line pressure test results, overall system check results, cathodic protection inspection results and uploaded photo documentation relative to the tank, tank system and/or tank components. An example of a safety inspection form is illustrated in FIG. 2. Customer name and address information is listed at the top. The technician provides the remaining data as part of the inspection process.

Although the residential-supply side of the propane industry is under obligation from insurance underwriters, certain aspects of NFPA regulation and industry best practices there were not universally utilized inspection forms for all the various inspections required. One non-limiting embodiment includes the development of standardized forms for every inspection. The development of the inspections forms may also include legal review from industry experts. The embodiment includes the most universally applicable inspection process and procedure for every inspection required.

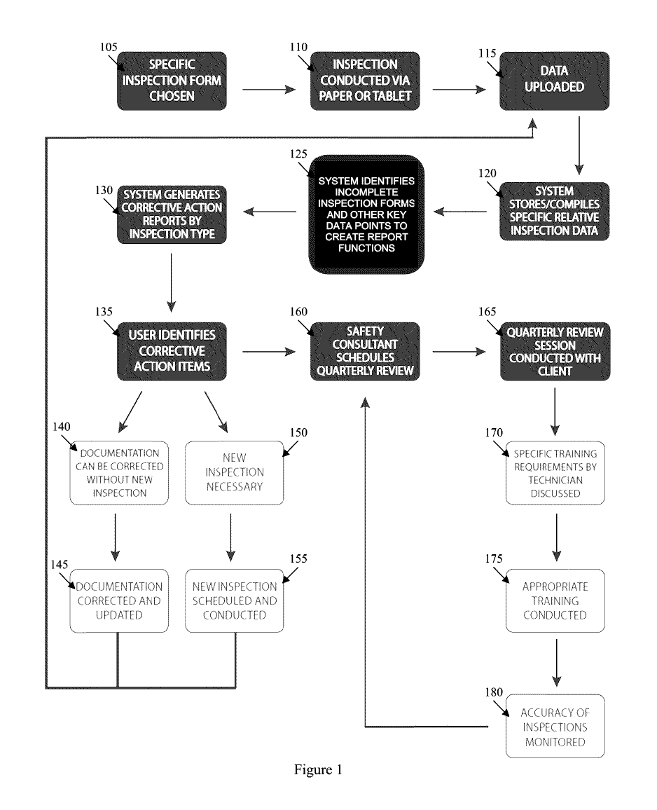

FIG. 1 represents the user's process flow. As shown in FIG. 1, a specific inspection form chosen at step 105. At step 110, the inspection is conducted using either a paper form or an electronic form, such as, on a tablet device. Once the inspection is completed, the data is uploaded at step 115.

The service provider's system stores and complies specific relative inspection data as shown in step 120. The system identifies incomplete inspection forms and other key data points to create report functions at step 125. At step 130, corrective action reports by inspection type are created.

The user identifies corrective action items on the report at step 135. In step 140, the item is identified as one where the documentation can be corrected without new inspection. At step 145, the documentation is corrected and the process returns to step 115 where the data is (re)updated.

On the other hand, the item may be identified as one where a new inspection is deemed necessary to resolve the item as in step 150. In this case, the new inspection is scheduled and conducted at step 155. After the new inspection is completed, the process returns to step 115 and the data is uploaded.

The process may also include performing various reviews and/or trainings, such as, having a safety consultant schedule a quarterly review at step 160. At step 165, the quarterly review session is conducted with the client. During the review, specific training requirements by technician may be discussed as in step 170. These requirements may be identified based on analysis of the correction actions identified in step 130. At step 175, the appropriate training is conducted. This training may be performed individually for each technician based on their specific training requirements or in larger groups using more generalized training requirements. At step 180, the system may monitor the accuracy of inspections by tracking which corrective action items are identified. This information may then be used in future quarterly reviews and training.

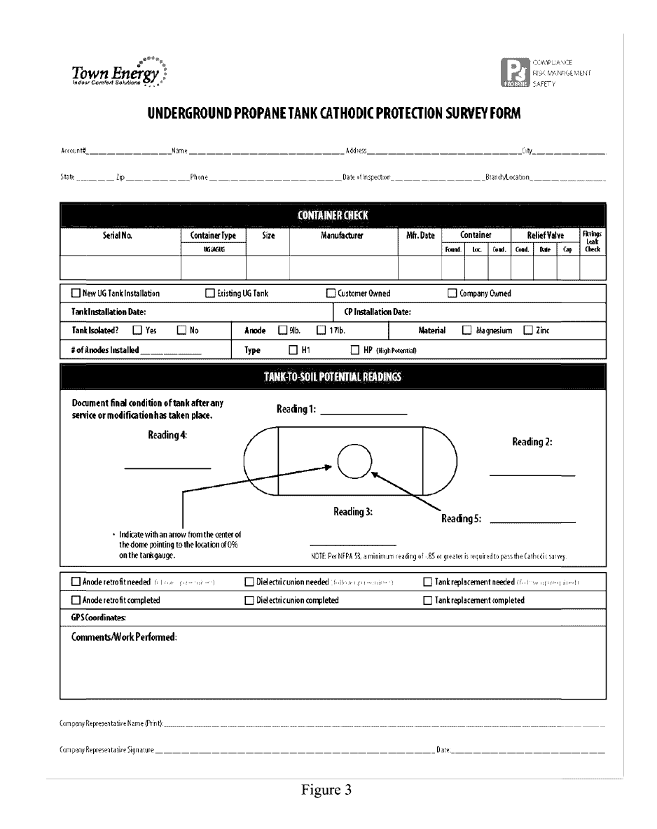

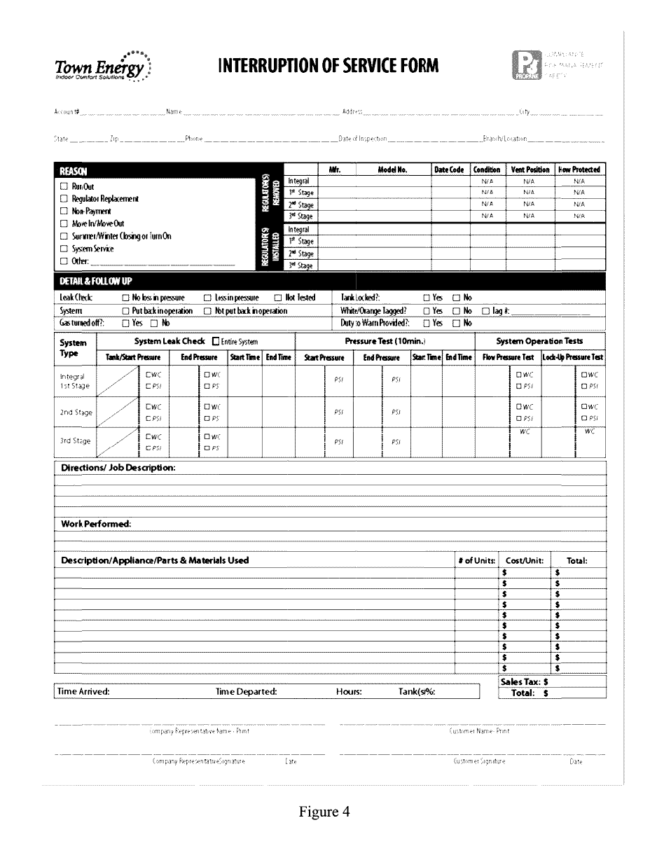

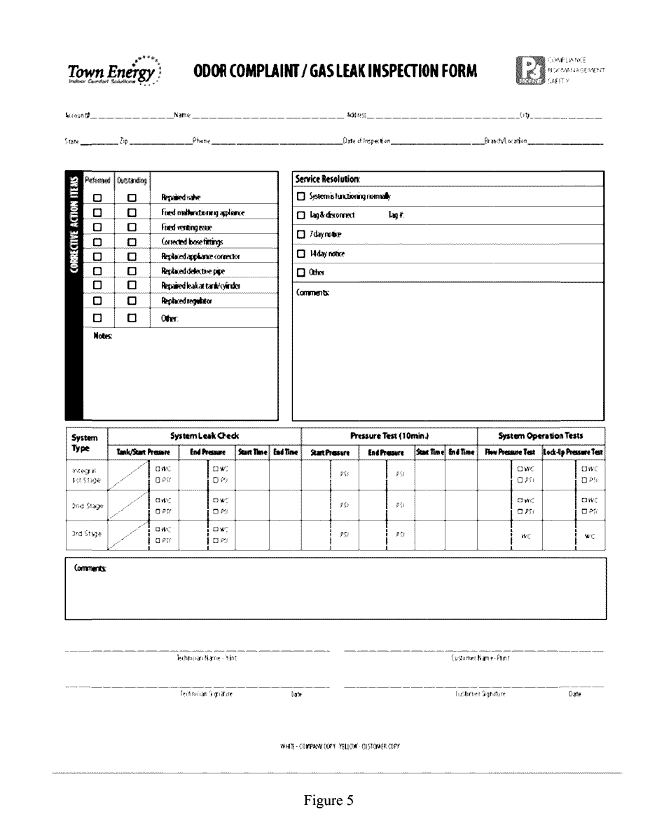

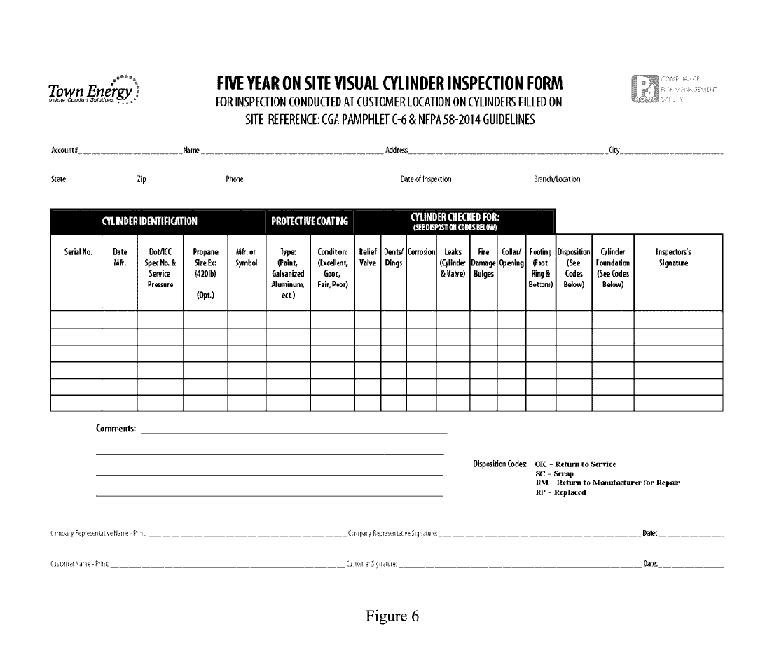

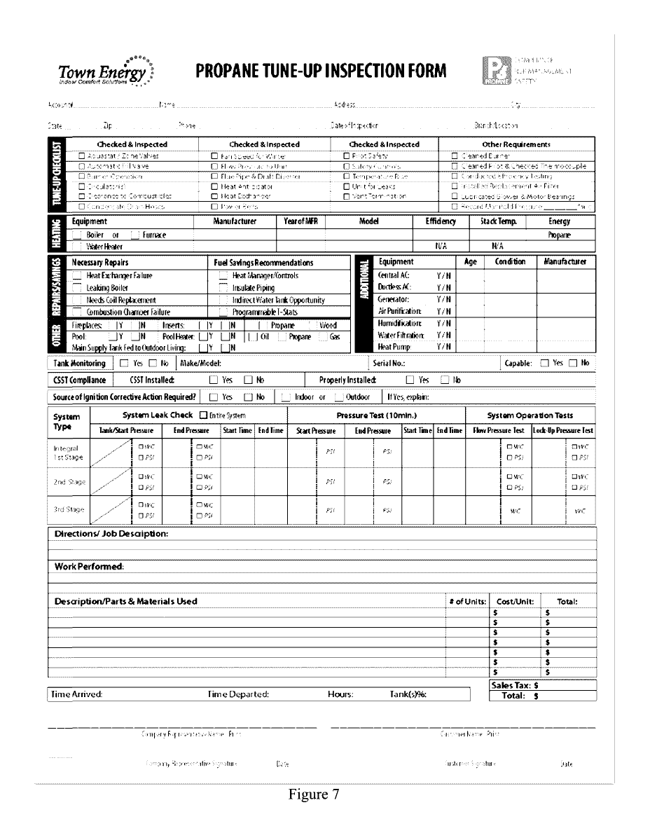

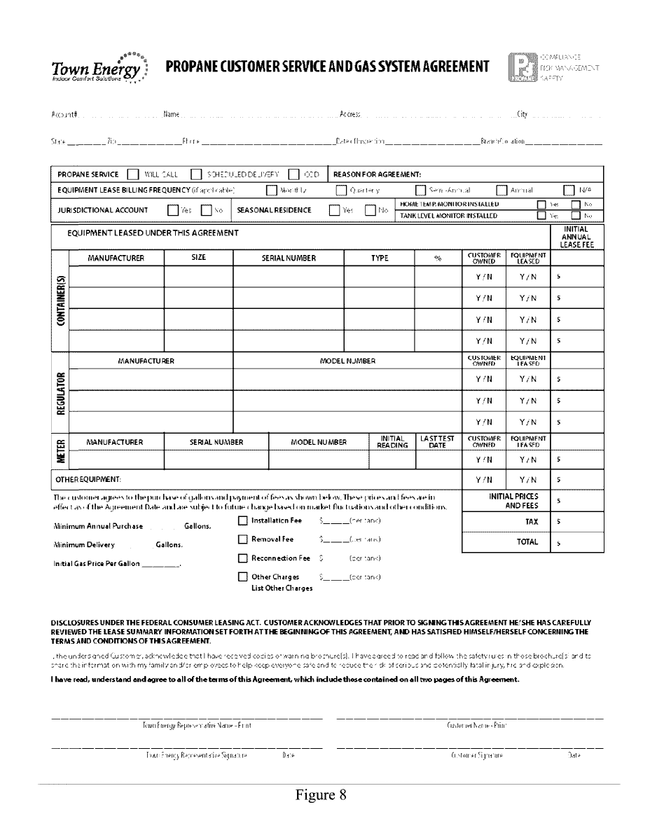

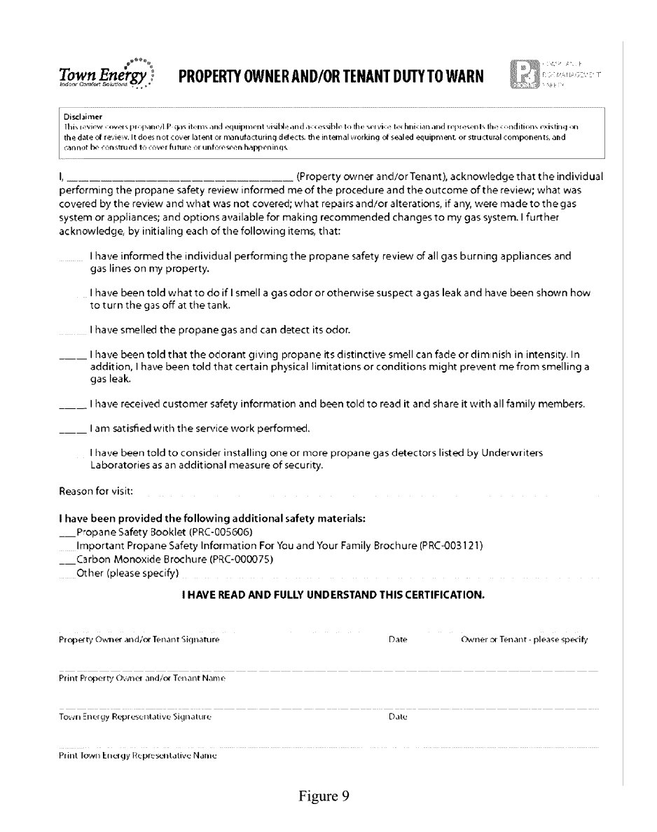

FIG. 2-9 reference the various inspection forms that represent compliance with specific assessments based on the residential requirements and/or activity being conducted by the dealer, such as, new equipment installation, odor complaint inspection report, interruption of service form, etc.

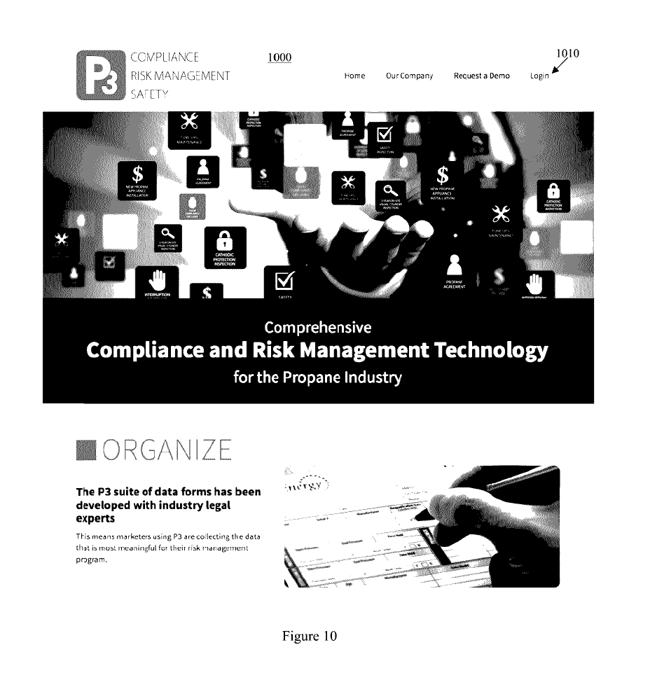

FIG. 10 shows the home web page 1000 of the system which is the entry point for users. By selecting the login option 1010, users are prompted for verification (e.g., by supplying a password) in order to gain access to their user system. Each user is set up as a company (propane supplier) and individual users such as safety personnel, management, and data entry personnel are given individual passwords.

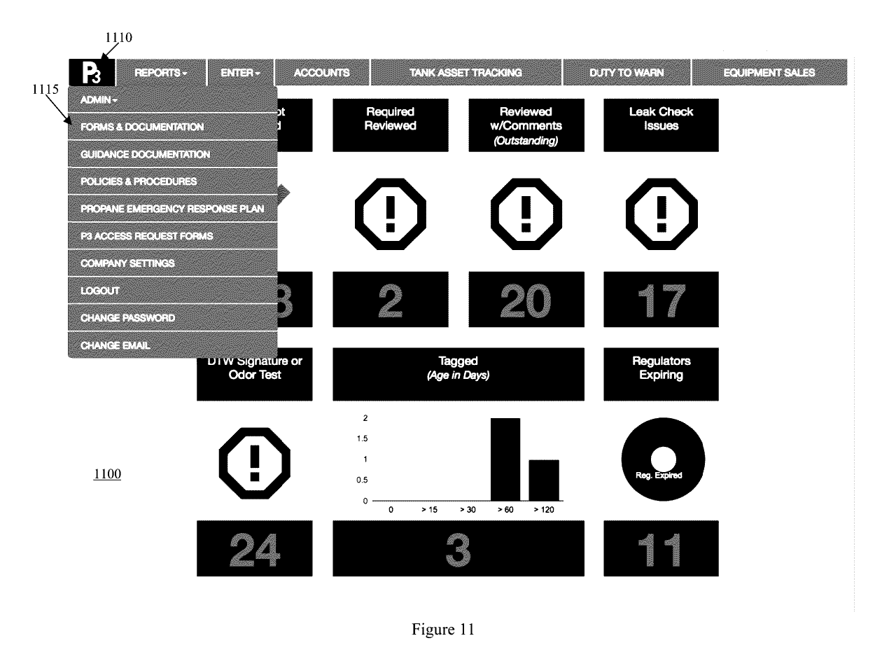

FIG. 11 shows a web page 1100 providing users with a choice of administrative functions including: forms and documentation, guidance documentation (training documents that align with inspection forms and provide a step-by-step explanation of how to complete the forms correctly) and other relative functions. These administrative functions may be access by selecting the administration tab 1110 (displayed as the P3 logo). This causes the list 1115 to be displayed where the user can choose an administrative function to perform.

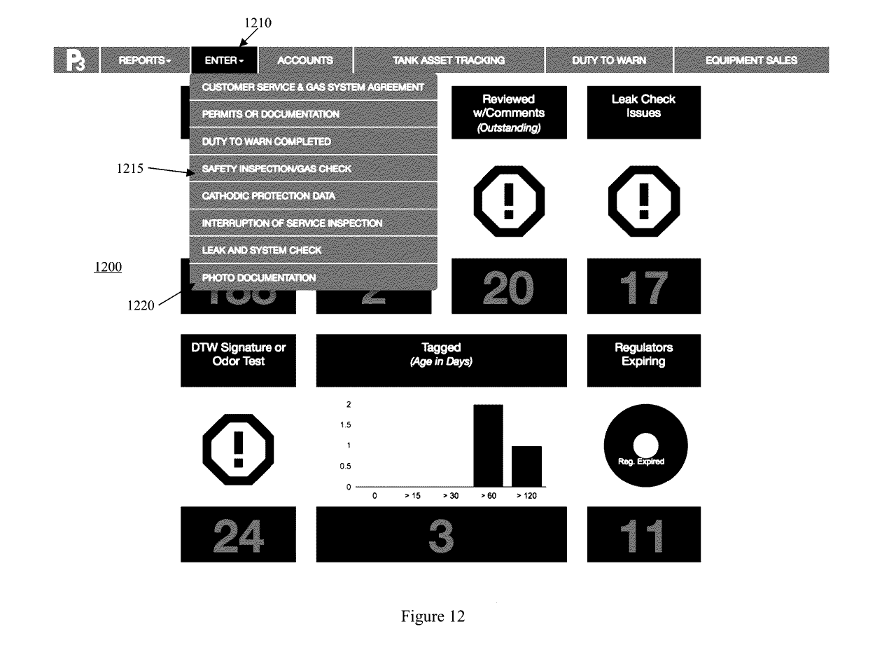

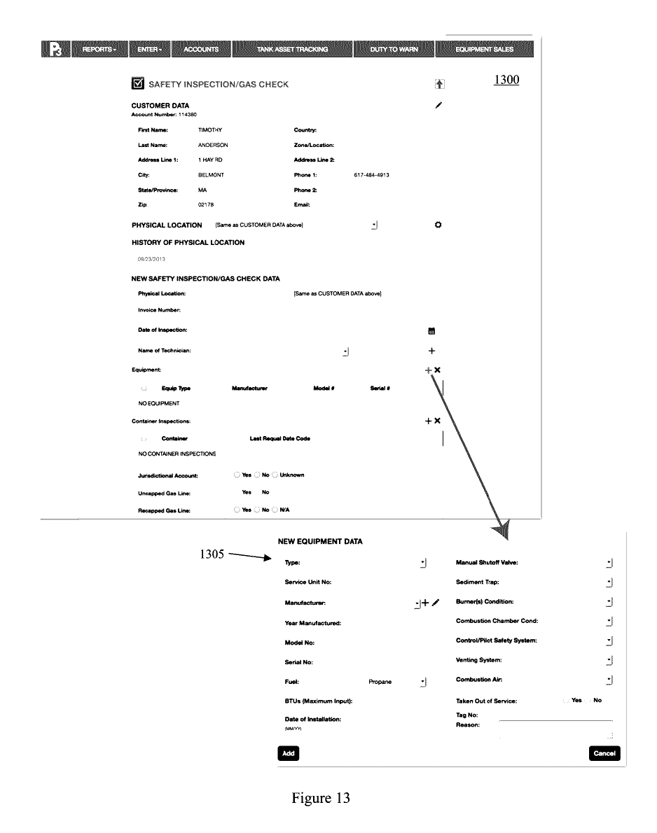

The Enter Inspection function (listed under the Enter tab 1210 of FIG. 12) permits entry of inspection information. Selecting the Safety Inspection/Gas Check data entry field 1215 causes the system to display Safety Inspection/Gas Check page 1300 as shown in FIG. 13.

The system analyzes data relative to the inspections and automatically catalogues inspections for various types of inaccuracies. For example, pressure tests are conducted to assure that line leaks are identified. This test requires a “hold time” of 3 to 5 minutes in the line while the pressure is established at 9.5 PSI. Any loss of pressure would be indicated by a pressure drop below 9.5 PSI over the period of “hold time”.

The technician conducting the test would establish both a hold time and exact pressure index before beginning the procedure. Any pressure loss would be indicated on the inspection form. Should any inspection documentation designate a loss of pressure, this would indicate that: a) a problem with the line was identified/repaired, but the documentation was not updated in the field with an additional test after the corrective action, b) that an issue was discovered but not addressed with appropriate corrective action, or c) the inspection was incorrectly documented in the field and represents a false positive where no issue actually existed.

This critically important testing process has been historically left up to a single person with no review process. Previously, systems did not have the capability to analyze thousands of records within the inspection portfolio of a dealer, as all records were paper and no data system existed to analyze key aspects of each inspection procedure. In an embodiment, the output of the system process results in a simple and effective way to analyze every inspection for accuracy, completeness, and most importantly for follow through on necessary corrective action.

FIG. 13 also depicts a window 1305 (such as, a pop-up window) for inputting new equipment data which populates a record of installation and precipitates the necessity for a line pressure test. When new equipment is installed, the system searches for and compares dates of line pressure tests at the location and identifies whether a line pressure test was conducted at the time of the installation. This is another critical safety related function of one, non-limiting embodiment as most propane related explosions or fires are a result of equipment installations.

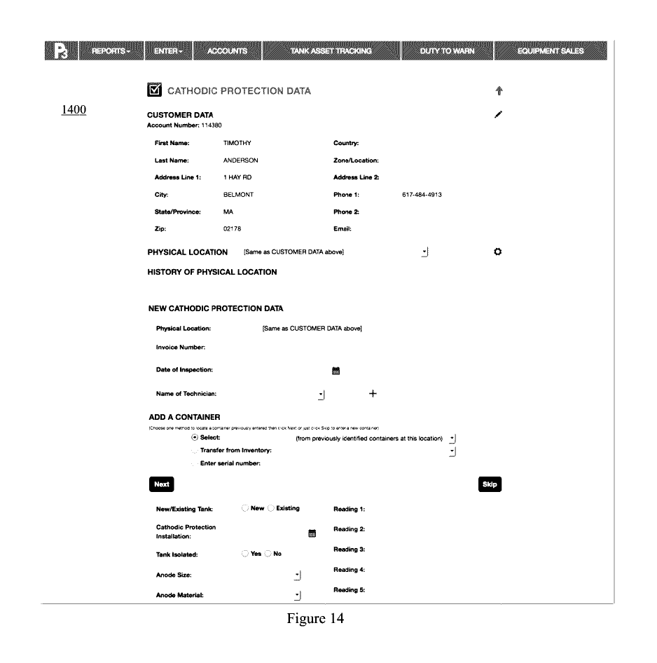

FIG. 14 represents the data entry portal webpage 1400 for Cathodic Protection inspections. Underground storage tanks are usually larger than above ground tanks and by the nature of the installation, these tanks are not visually available for inspection.

The method for determining tank integrity is called a cathodic protection inspection. Underground tanks corrode as a result of electrical flows associated with the steel components of the tank. The industry's preferred method of corrosion protection is the sacrificial anode system. Sacrificial anodes are metals that are more electrically active than the steel used to manufacture underground storage tanks, for example zinc. They are usually welded to or attached to the steel underground tank before the installation and subsequent burial. Because the anode is more active, electrical current flows from the anode rather than the steel tank and, therefore, the steel tank is protected as long as the anode has substance.

The cathodic protection test involves using an electrical measuring device and testing the soil around the underground tank for electrical activity. That activity indicates whether the sacrificial anode is still working or if the anode needs replacement. The importance of the periodic test is to determine if and when a sacrificial anode should be replaced. That replacement ideally occurs prior to the anode losing all of its substance and effectiveness. The system catalogues the test information and analyzes the electrical test data to determine and predict when an anode should be replaced and on what timetables the next cathodic inspection should occur.

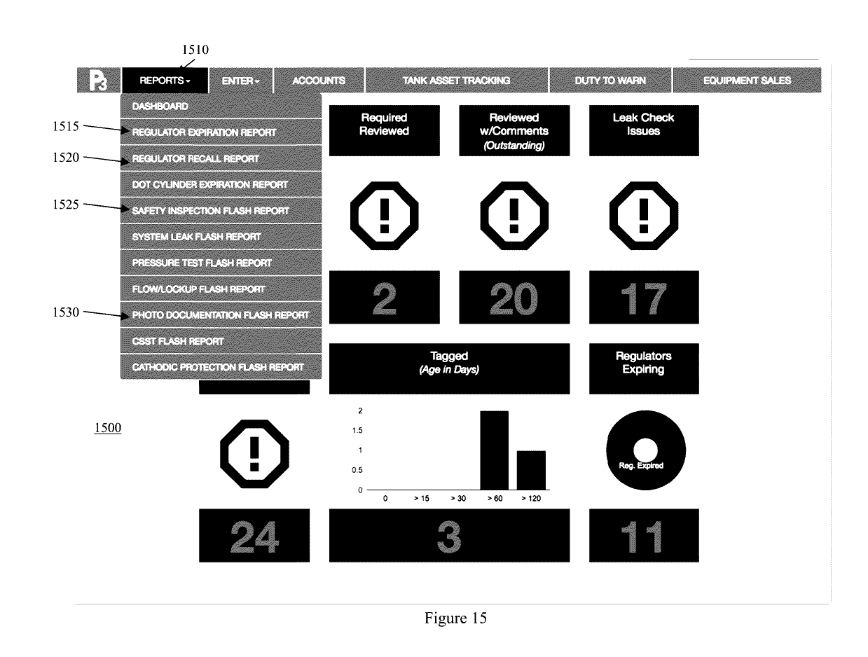

FIG. 15 shows a web page 1500 for choosing various reports available in the system and a user dashboard summary of actionable corrective actions. The Regulator Expiration Report, which can be accessed using the Regulator Expiration Report field 1515 on the Reports tab 1510, identifies tank system regulators that require replacement based on manufacturers requirements.

A regulator reduces pressure from the propane storage tank to a level commensurate with the systems appliance requirements. There are a myriad of regulator manufacturers and most have a unique method for coding dates of manufacture and timetables for their product to be retired/replaced. This complexity in a paper-driven system has historically assured that the industry has been unable to consistently replace these devices on the timetables required by the manufacturers. The system has been programmed to correlate manufacturers of regulators with their specific and unique numerical and digital codes. This information is used to produce a report that predicts when regulators need replacement by specific residence and location. System users (e.g., propane dealers) can therefore easily identify in advance all replacements required and efficiently schedule replacements.

Periodically regulator manufacturers enact a product recall. The recall is similar to that of other product recalls when a failure rate of the product or component device is unacceptably high or an endangerment to the product user. Selecting the Regulator Expiration Report field 1520 displays a Regulator Recall report that catalogues such recalls. The system searches within the user's databases for the specific recall data by manufacturer, date of manufacture, serial number and/or other criterion that identifies the product in question. The system then produces a report cataloguing all such regulators that the user has in the field by location and customer account. Previously, this electronic cataloguing, given the myriad of complexities described above, was essentially impossible.

Two types of above ground propane storage tanks are American Society of Mechanical Engineers (ASME) and Department of Transportation (DOT). ASME tanks are installed as a fixed facility at the location of use, usually on a cement pad. These tanks are refilled via a propane tanker commonly called a bobtail. DOT tanks are stored at the residence and may be replaced (e.g., with different tanks) when empty, via a delivery truck.

DOT tanks are checked with a 5, 7, or 12 year inspection. Normally these inspections occur at a storage or replenishment facility that refills and stores the tanks until they are reshipped to another location for use. The system identifies all DOT tanks in a user's portfolio and produces a chronology report indicating the tanks that need inspection, by location and account number. This provides and easy and efficient way to be compliant with DOT regulations.

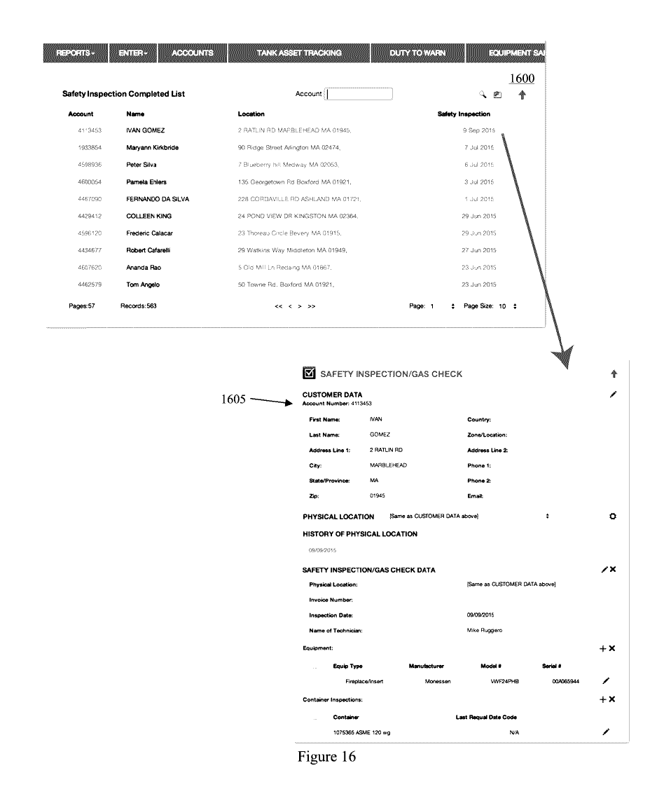

Selecting the Safety Inspection Flash Report field 1520 on the Reports tab 1510 shown in FIG. 15 displays the Safety Inspection Flash Report 1600 as illustrated in FIG. 16. This report outlines in a simple and easy to view format all corrective action necessary within the entire scope of those inspections. This includes leak check issues, expiring regulators, tank systems that are tagged for non-compliance, and other notable managerial data points. Detailed information for individual checks may be displayed, such as in a pop-up window 1605, by selecting the associated entry in the Safety Inspection Flash Report 1600.

A System Leak Flash Report catalogues all locations with an issue resulting from a pressure test that indicated the need to check the line for a leak. This is important because even a minor drop in pressure during the pressure test can indicate the release of propane which is both a fire and explosion hazard under that condition. The leak test is used to discover where in the line an escape may be occurring. It is usually conducted by applying soap and water along entire line, whereby the escaping propane would be noted by the bubble effect created by the release. After the escape location is identified corrective action in the form of maintenance or replacement is performed. Thereafter another pressure test is performed to assure the issue has been corrected.

The Pressure Test Flash Report provides results from conducting the pressure test. The report provides locations and account numbers of all residences that are identified with an issue. These would commonly be: a) a problem with a line was identified (e.g., pressure loss) and repaired, but the documentation was not updated in the field with an additional test after the corrective action; b) that an issue was discovered but not addressed with appropriate corrective action; or c) the inspection was incorrectly documented in the field and represents a false positive where no issue actually existed. The importance of correctly documenting all aspects of the inspection processes is not only for homeowner safety, but incorrect documentation can create liability for the propane dealer in the event that specific documentation is needed in defense of some type of litigation.

A Flow and Lockup Flash Report indicates regulators that may be functioning outside the specified parameters for pound per square inch (PSI) and lockup. The regulator is a critical component of the propane system for both proper functioning and safety. The flow and lockup test determines if: a) a regulator is allowing the specified level of PSI into the line system, and b) if the regulator closes properly when there is no demand. Both of these functions are critical for operational and safety related purposes. The flash report indicates and catalogues those locations by account number where the system has determined, via data analysis, there is an issue. The system also indicates if a flow and lockup test has not been performed.

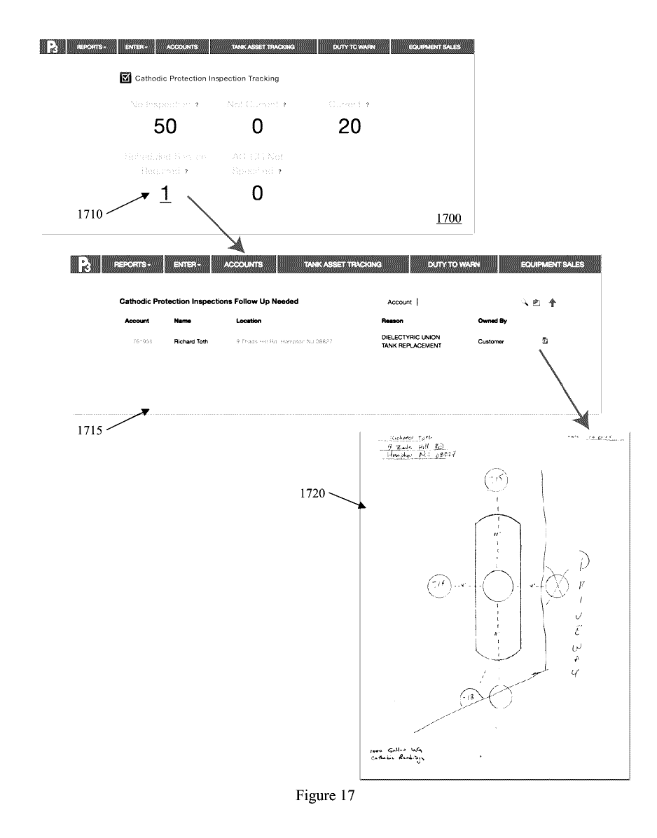

Cathodic protection was described in detail above. The Cathodic Protection Flash Report 1700 shown in FIG. 17 provides users with a chronological cataloguing of all underground propane storage tanks in their portfolio. The cataloguing depicts which account locations require a cathodic protection test and at what time. This important feature is customizable as regulations and inspection requirements can vary by state.

As shown, selecting the indication of scheduled service required 1710 displays a Cathodic Protection Inspections Follow Up Needed window 1715. This window 1715 allows users to see specific details and access related documents. As shown, an image 1720 of a technician's diagram of the tank is displayed. As discussed in greater detail, such images may be uploaded using the photo documentation system.

Corrugated stainless steel tubing (CSST) has been in use in the propane industry for many years. It is used as conveyance line for propane gas, primarily from the propane tank into the residence. Recently, CSST has been identified as susceptible to damage or as a catalyst for fire or explosion when exposed to lightning. Due to its previous wide-spread use and recently being identified as a potential safety hazard, CSST installations have come under scrutiny. Many historic installations using CSST were not electrically grounded, which is now a requirement. The CSST Flash Report, accessed via a field under the reports tab 1510 in FIG. 15, catalogues all out-of-compliance installations by location and account number. This provides an effective roadmap for a user to quickly and efficiently upgrade or replace residences with CSST issues.

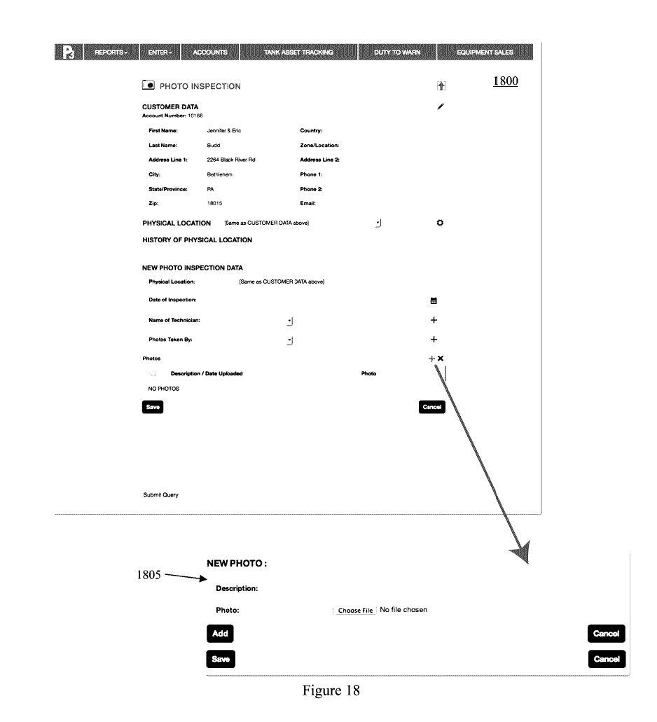

Various embodiments also allow users to include image data, such as photos, scanned copies of inspection forms, etc. Photo documentation can be an important liability reduction tool for the system user. FIGS. 18, 19, and 20 show various aspects of the system. Users may customize the photo documentation system to align with internal policy and preference. A value of photo documentation is to time stamp and verify that the external propane system is in compliance at the time of inspection. For example, the propane tank may not be situated within 10 feet of a potential combustion source; represented by electrical appliances or windows that may expose an internal source to the propane tank. When a source is in violation it is referred to as point of transfer issue.

The system provides users with the ability to upload actual visual documentation in individual account files. The importance of this documentation is that point of transfer violations can cause fire or explosions and in virtually all documented cases the device that caused the issue was installed or located near the fixed propane tank after the original installation. Photo documentation serves as a liability reduction tool for users and more importantly, a process for identifying potential hazards that can be used to educate and communicate with the homeowner.

FIG. 18 illustrates a Photo Inspection webpage 1800. This webpage 1800 allows the user to upload photos or other image data. Additional information may be associated with the image data, such as, the location, date, technician, etc. As one, non-limiting example, pop-up window 1805 may be used to provide a description of the images and to load each image individually.

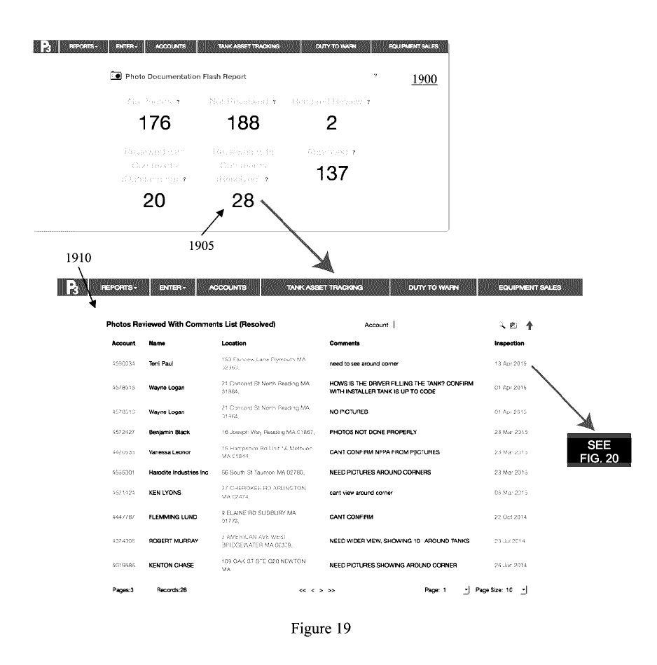

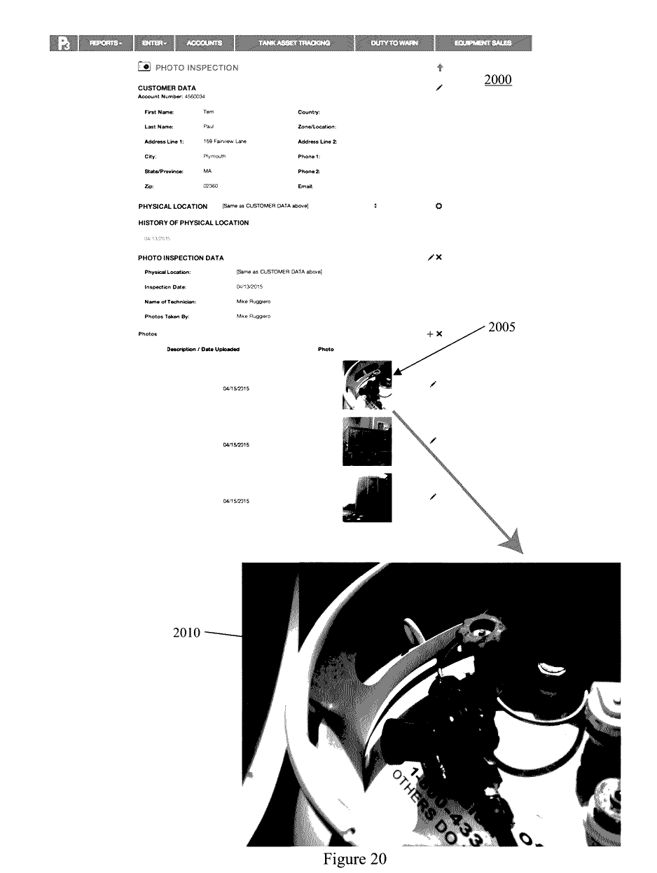

FIG. 19 shows a Photo Documentation Flash Report webpage 1900 which can be accessed using the Photo Documentation Flash Report field 1530 under the Reports tab 1510 shown in FIG. 15. The webpage 1900 provides details regarding the number of photos stored. Selecting one of the data fields, for example, the Reviewed with Comments (Resolved) field 1905 displays a more detailed list 1910. The entries in the list 1910 may also be selected in order to display the relevant information, such as shown in webpage 2000 in FIG. 20.

In addition to consumer data and photo inspection data, the webpage 2000 also provides a thumbnail image 2005 of the photos associated with the inspection. The user can access a larger image 2010 by selecting the small image 2005.

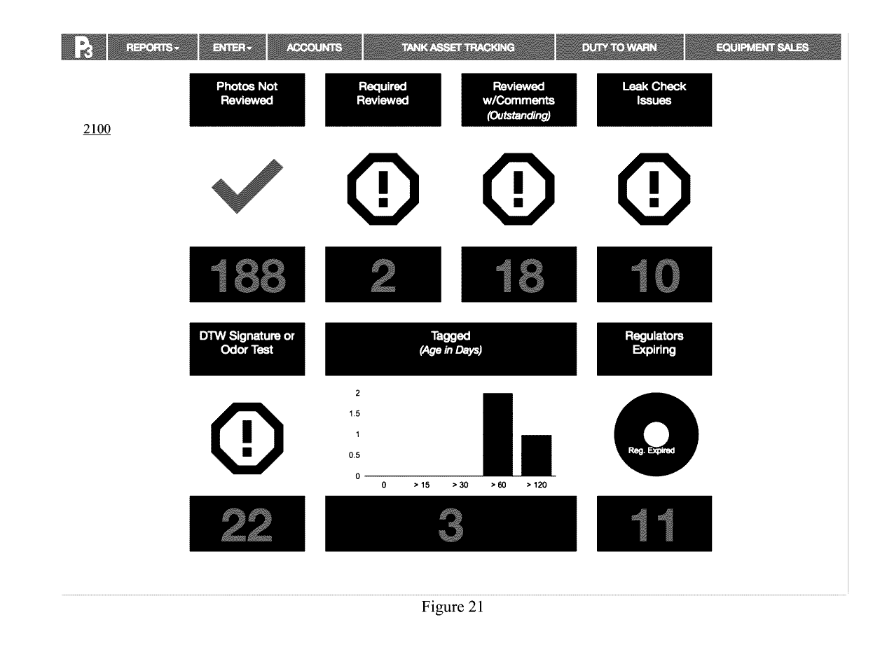

FIG. 21 shows a user flash report depicting all corrective actions and document reviews required. Each category provides for drill-down into account details that include: all safety inspection data, original uploads of all safety inspections created in the field, photo documentation, appliances installed or located at each account, and customer signature sign-offs on agreements and Duty to Warn (DTW) notifications.

The system provides an extremely versatile and beneficial management tool for propane dealers to comply with regulations, requirements, and best practice. The system also provides homeowner's with the direct benefit of a vastly improved safety documentation program implemented by the industry.

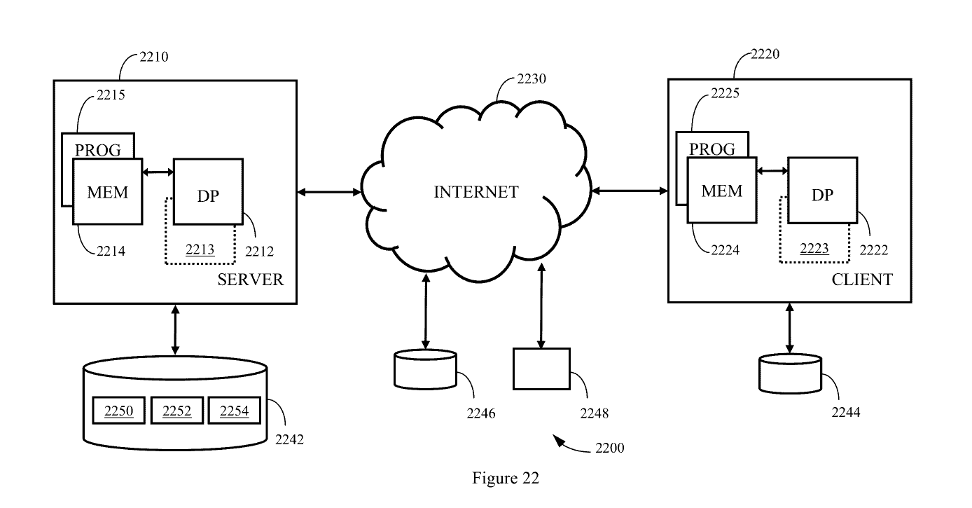

FIG. 22 shows a block diagram of a system 2200 that is suitable for use in practicing various embodiments. In the system 2200 of FIG. 22, the server 2210 includes a controller, such as a data processor (DP) 2212 and a computer-readable medium embodied as a memory (MEM) 2214 that stores computer instructions, such as a program (PROG) 2215. Server 2210 may communicate with a client 2220, for example, via the internet 2230.

Client 2220 includes a controller, such as a data processor (DP) 2222 and a computer-readable medium embodied as a memory (MEM) 2224 that stores computer instructions, such as a program (PROG) 2225. Server 2210 and/or client 2220 may also include a dedicated processor, for example internet communication processors 2213, 2223. Both server 2210 and/or client 2220 may communicate with a remote technician device 2248, for example, via the internet 2230 (as shown), and/or via direct communications channels (such as a wireless connection or a physical connection).

Databases 2242, 2244, 2246 may be connected directly to the server 2210, the client 2244 or the internet 2230. As shown, database 2242 stores inspection data 2250, image data 2252 and customer data 2254; however, this information may be stored separately (or together) in any of the databases 2242, 2244, 2246.

The programs 2215, 2225 may include program instructions that, when executed by the DP 2212, 2222, enable the server 2210 and/or client 2220 to operate in accordance with an embodiment. That is, various embodiments may be carried out at least in part by computer software executable by the DP 2212 of the server 2210, the DP 2222 of the client 2220, by hardware, or by a combination of software and hardware.

In general, various embodiments of the server 2210 and/or client 2220 may include tablets and computers, as well as other devices that incorporate combinations of such functions.

The MEM 2214, 2224 and databases 2242, 2244, 2246 may be of any type suitable to the local technical environment and may be implemented using any suitable data storage technology, such as magnetic memory devices, semiconductor based memory devices, flash memory, optical memory devices, fixed memory and removable memory. The DP 2212, 2222 may be of any type suitable to the local technical environment, and may include general purpose computers, special purpose computers, microprocessors and multicore processors, as non-limiting examples.

As described above, various embodiments provide a method, apparatus and computer program(s) to analyze data regarding the condition of fuel tank systems and determining an inspection process accordingly.

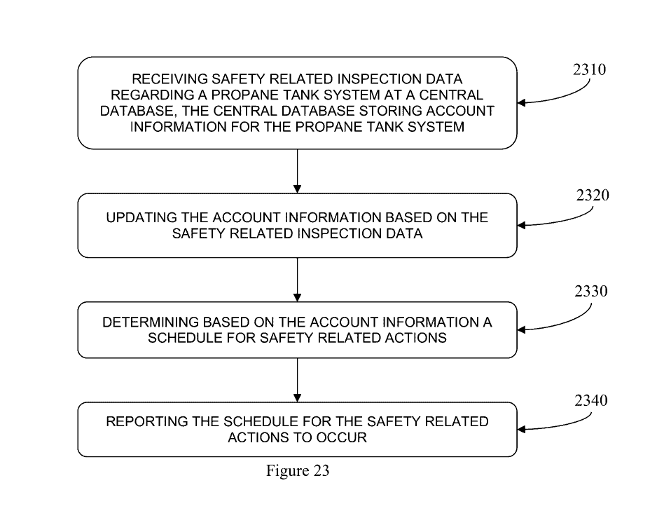

FIG. 23 is a logic flow diagram that illustrates a method, and a result of execution of computer program instructions, in accordance with various embodiments. In accordance with an embodiment a method performs, at Block 2310, a step of receiving safety related inspection data regarding a propane tank system at a central database. The central database stores account information for the propane tank system. At Block 2320, the method performs a step of updating the account information based on the safety related inspection data. A step of determining based on the account information a schedule for safety related actions is performed at Block 2330. The method also performs, at Block 2340, a step of reporting the schedule for the safety related actions to occur.

The various blocks shown in FIG. 23 may be viewed as method steps, as operations that result from use of computer program code, and/or as one or more logic circuit elements constructed to carry out the associated function(s).

An embodiment provides a method for cataloguing and analyzing safety inspection data from a variety of differing required inspections. The method includes providing a central database containing account information for each homeowner's propane tank system. Safety related inspection data based on the infrastructure of the system is entered into the database. The method also includes processing that data to assure that required and recommended maintenance and other safety related corrective actions occur at specified intervals or at the time of immediate need.

Another embodiment provides a method for cataloguing and analyzing safety inspection data from a variety of differing inspections. The method includes receiving safety related inspection data regarding a propane tank system at a central database of a service provider. The central database stores account information for the propane tank system, for example, for each customer of the propane dealer client of the service provider. The method includes updating the account information based on the safety related inspection data. Based on the (updated) account information the service provider determines a schedule for safety related actions, such as, regular inspections, follow-up inspections to correct errors in the data, etc. The method also includes reporting the schedule for the safety related actions to occur.

In a further embodiment of the method above, the schedule for the safety related actions includes safety related actions which are to occur immediately and/or at specified intervals.

In another embodiment of any one of the methods above, receiving the safety related inspection data includes receiving an image of an inspection form and populating the safety related inspection data based on entries in the inspection form. The image may be a scanned copy of an inspection form.

In a further embodiment of any one of the methods above, receiving the safety related inspection data includes receiving entries in a digital inspection form; determining whether at least one entry is not acceptable; and, in response to determining that at least one entry is not acceptable, indicating an error and requesting a corrected entry. The entries may be received individually as they entered such that the requested correction is to be made before moving to the next entry. Alternatively, all entries in the form may be received at one time and those entries with errors are identified. The errors may be blank entries, incorrect data entries (e.g., outside of practical/acceptable ranges), etc.

In another embodiment of any one of the methods above, receiving the safety related inspection data includes receiving a digital inspection form; determining whether at least one entry in the digital inspection form is incomplete; and in response to determining that at least one entry is incomplete, indicating an error and requesting a corrective action. The corrective action may include performing a new inspection of the propane tank system; and/or inputting additional information (for example, to correct an incorrect entry).

In a further embodiment of any one of the methods above, receiving the safety related inspection data includes scanning propane tank system identifying information and autofilling entries in the safety related inspection data based on the propane tank system identifying information. Scanning the propane tank system identifying information may include scanning a radio frequency tag, scanning a barcode, and/or performing character recognition on an image of the propane tank system.

In another embodiment of any one of the methods above, the method also includes identifying at least one regulatory filing and/or other filing to be performed based on the propane tank system and automatically filling out documentation for the filing based on the account information.

In a further embodiment of any one of the methods above, the account information includes photographic images of the propane tank system.

In another embodiment of any one of the methods above, the method includes generating a daily schedule for a technician based at least in part on the schedule for the safety related actions. As non-limiting embodiments, the daily schedule may include a prioritized list of actions to performed, a listing of actions based on a projected location of the technician (for example, identifying non-critical actions which are within a threshold distance from a scheduled service call), and/or follow-up actions in order to fill in gaps in the account information (for example, informing the technician to record information that was not recorded previously, such as equipment data from existing devices).

In a further embodiment of any one of the methods above, the safety related actions include actions to correct errors in the safety related inspection data, and the method also includes recommending training based on the errors. For example, repeated instances of a similar error by a single technician or by multiple technicians may prompt additional training regarding the entry.

In another embodiment of any one of the methods above, the method includes identifying additional sales options for the client based on the account information. For example, indicating a possible upgrade in their equipment and/or additional propane devices.

A further embodiment provides an apparatus for cataloguing and analyzing safety inspection data from a variety of differing inspections, such as, a service provider server. The apparatus includes at least one processor and at least one memory storing computer program code. The at least one memory and the computer program code are configured to, with the at least one processor, cause the apparatus to perform various actions. The actions include receiving safety related inspection data regarding a propane tank system at a central database of a service provider. The central database stores account information for the propane tank system. The actions include updating the account information based on the safety related inspection data. Based on the account information the service provider determines a schedule for safety related actions. The actions also include reporting the schedule for the safety related actions to occur.

In another embodiment of the apparatus above, the schedule for the safety related actions includes safety related actions which are to occur immediately and/or at specified intervals.

In a further embodiment of any one of the apparatus above, receiving the safety related inspection data includes receiving an image of an inspection form and populating the safety related inspection data based on entries in the inspection form. The image may be a scanned copy of an inspection form.

In another embodiment of any one of the apparatus above, receiving the safety related inspection data includes receiving entries in a digital inspection form; determining whether at least one entry is not acceptable; and, in response to determining that at least one entry is not acceptable, indicating an error and requesting a corrected entry. The entries may be received individually as they entered such that the requested correction is to be made before moving to the next entry. Alternatively, all entries in the form may be received at one time and those entries with errors are identified.

In a further embodiment of any one of the apparatus above, receiving the safety related inspection data includes receiving a digital inspection form; determining whether at least one entry in the digital inspection form is incomplete; and in response to determining that at least one entry is incomplete, indicating an error and requesting a corrective action. The corrective action may include performing a new inspection of the propane tank system; and/or inputting additional information.

In another embodiment of any one of the apparatus above, receiving the safety related inspection data includes scanning propane tank system identifying information and autofilling entries in the safety related inspection data based on the propane tank system identifying information. Scanning the propane tank system identifying information may include scanning a radio frequency tag, scanning a barcode, and/or performing character recognition on an image of the propane tank system.

In a further embodiment of any one of the apparatus above, the actions also include identifying at least one regulatory filing and/or other filing to be performed based on the propane tank system and automatically filling out documentation for the filing based on the account information.

In another embodiment of any one of the apparatus above, the account information includes photographic images of the propane tank system.

In a further embodiment of any one of the apparatus above, the actions include generating a daily schedule for a technician based at least in part on the schedule for the safety related actions. As non-limiting embodiments, the daily schedule may include a prioritized list of actions to performed, a listing of actions based on a projected location of the technician, and/or follow-up actions in order to fill in gaps in the account information.

In another embodiment of any one of the apparatus above, the safety related actions include actions to correct errors in the safety related inspection data, and the actions also include recommending training based on the errors.

In a further embodiment of any one of the apparatus above, the actions include identifying additional sales options for the client based on the account information.

In another embodiment of any one of the apparatus above, the apparatus is embodied in a server.

In a further embodiment of any one of the apparatus above, the apparatus is embodied as a central database server in a system. The system may also include a plurality of client devices (e.g., a client's desktop computer or other internet based device). Each client device has at least one client processor and at least one client memory storing client computer program code. The at least one client memory and the client computer program code are configured to, with the at least one client processor, cause the client device to send the safety related inspection data to the central database server; and to receive the schedule for the safety related actions to occur. The system may also include remote devices, such as tablets, which a technician may use to send the safety related inspection data to the central database server and/or a client device.

Another embodiment provides a computer readable medium for cataloguing and analyzing safety inspection data from a variety of differing inspections. The computer readable medium is tangibly encoded with a computer program executable by a processor to perform actions. The actions include receiving safety related inspection data regarding a propane tank system at a central database of a service provider. The central database stores account information for the propane tank system. The actions include updating the account information based on the safety related inspection data. Based on the account information the service provider determines a schedule for safety related actions. The actions also include reporting the schedule for the safety related actions to occur.

In a further embodiment of the computer readable medium above, the schedule for the safety related actions includes safety related actions which are to occur immediately and/or at specified intervals.

In another embodiment of any one of the computer readable media above, receiving the safety related inspection data includes receiving an image of an inspection form and populating the safety related inspection data based on entries in the inspection form. The image may be a scanned copy of an inspection form.

In a further embodiment of any one of the computer readable media above, receiving the safety related inspection data includes receiving entries in a digital inspection form; determining whether at least one entry is not acceptable; and, in response to determining that at least one entry is not acceptable, indicating an error and requesting a corrected entry. The entries may be received individually as they entered such that the requested correction is to be made before moving to the next entry. Alternatively, all entries in the form may be received at one time and those entries with errors are identified.

In another embodiment of any one of the computer readable media above, receiving the safety related inspection data includes receiving a digital inspection form; determining whether at least one entry in the digital inspection form is incomplete; and in response to determining that at least one entry is incomplete, indicating an error and requesting a corrective action. The corrective action may include performing a new inspection of the propane tank system; and/or inputting additional information.

In a further embodiment of any one of the computer readable media above, receiving the safety related inspection data includes scanning propane tank system identifying information and autofilling entries in the safety related inspection data based on the propane tank system identifying information. Scanning the propane tank system identifying information may include scanning a radio frequency tag, scanning a barcode, and/or performing character recognition on an image of the propane tank system.

In another embodiment of any one of the computer readable media above, the actions also include identifying at least one regulatory filing and/or other filing to be performed based on the propane tank system and automatically filling out documentation for the filing based on the account information.

In a further embodiment of any one of the computer readable media above, the account information includes photographic images of the propane tank system.

In another embodiment of any one of the computer readable media above, the actions include generating a daily schedule for a technician based at least in part on the schedule for the safety related actions. As non-limiting embodiments, the daily schedule may include a prioritized list of actions to performed, a listing of actions based on a projected location of the technician, and/or follow-up actions in order to fill in gaps in the account information.

In a further embodiment of any one of the computer readable media above, the safety related actions include actions to correct errors in the safety related inspection data, and the actions further include recommending training based on the errors.

In another embodiment of any one of the computer readable media above, the actions include identifying additional sales options for the client based on the account information.

In a further embodiment of any one of the computer readable media above, the computer readable medium is a storage medium.

In another embodiment of any one of the computer readable media above, the computer readable medium is a non-transitory computer readable medium (e.g., CD-ROM, RAM, flash memory, etc.).

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A method for cataloguing and analyzing safety inspection data from a variety of differing inspections comprising:
receiving at a central database safety related inspection data regarding a propane tank system, the central database storing account information for the propane tank system;
updating the account information based on the safety related inspection data;
determining based on the account information a schedule for safety related actions; and
reporting the schedule for the safety related actions to occur.

2. The method of claim 1, wherein the schedule for the safety related actions includes safety related actions which are to occur at least one of: immediately; and at specified intervals.

3. The method of claim 1, wherein receiving the safety related inspection data comprises:
receiving an image of an inspection form; and
populating the safety related inspection data based on entries in the inspection form.

4. The method of claim 1, wherein receiving the safety related inspection data comprises:
receiving entries in a digital inspection form;
determining whether at least one entry is not acceptable; and
in response to determining that at least one entry is not acceptable, indicating an error and requesting a corrected entry.

5. The method of claim 1, wherein receiving the safety related inspection data comprises:
receiving a digital inspection form;
determining whether at least one entry in the digital inspection form is incomplete; and
in response to determining that at least one entry is incomplete, indicating an error and requesting a corrective action.

6. The method of claim 5, wherein the corrective action comprises at least one of:
performing a new inspection of the propane tank system; and inputting additional information.

7. The method of claim 1, wherein receiving the safety related inspection data comprises scanning propane tank system identifying information and autofilling entries in the safety related inspection data based on the propane tank system identifying information.

8. The method of claim 7, wherein scanning the propane tank system identifying information comprises at least one of: scanning a radio frequency tag, scanning a barcode, and performing character recognition on an image of the propane tank system.

9. The method of claim 1, further comprising identifying regulatory filing to be performed based on the propane tank system and automatically filling out documentation for the regulatory filing based on the account information.

10. The method of claim 1, wherein the account information comprises photographic images of the propane tank system.

11. The method of claim 1, further comprising generating a daily schedule for a technician based at least in part on the schedule for the safety related actions.

12. The method of claim 1, wherein the safety related actions comprise actions to correct errors in the safety related inspection data, and
the method further comprises recommending training based on the errors.

13. A system for maintaining a central database of account information for propane tank systems comprising:
a central database server having at least one server processor; and at least one server memory storing server computer program code, the at least one server memory and the server computer program code configured to, with the at least one server processor, cause the central database server to perform at least the following:
to receive safety related inspection data regarding a propane tank system at a central database server, the central database server storing account information for a propane tank system;
to update the account information based on the safety related inspection data;
to determine based on the account information a schedule for safety related actions; and
to report the schedule for the safety related actions to occur; and
a plurality of client devices, each client device having at least one client processor; and at least one client memory storing client computer program code, the at least one client memory and the client computer program code configured to, with the at least one client processor, cause the client device to perform at least the following:
to send the safety related inspection data to the central database server; and
to receive the schedule for the safety related actions to occur.

14. The system of claim 13, wherein the at least one server memory and the server computer program code are further configured to cause the central database server, when receiving safety related inspection data:
to receive at least one entry from a digital inspection form;
to determine whether at least one entry is not acceptable; and
in response to determining that at least one entry is not acceptable, to indicate an error and requesting a corrected entry.

15. The system of claim 13, wherein the safety related actions comprise at least one of:
performing a new inspection of the propane tank system; and inputting additional information.

16. The system of claim 13, wherein the account information comprises photographic images of the propane tank system.

17. The system of claim 13, wherein receiving the safety related inspection data comprises scanning propane tank system identifying information and autofilling entries in the safety related inspection data based on the propane tank system identifying information.

18. A computer readable medium tangibly encoded with a computer program executable by a processor to perform actions comprising:
receiving safety related inspection data regarding a propane tank system at a central database, the central database storing account information for the propane tank system;
updating the account information based on the safety related inspection data;
determining based on the account information a schedule for safety related actions; and
reporting the schedule for the safety related actions to occur.

19. The computer readable medium of claim 18, wherein receiving the safety related inspection data comprises:
receiving a digital inspection form;
determining whether at least one entry in the digital inspection form is incomplete; and
in response to determining that at least one entry is incomplete, indicating an error and requesting a corrective action.

20. The computer readable medium of claim 18, wherein the corrective action comprises at least one of: performing a new inspection of the propane tank system; and inputting additional information.
